(19) United States
(12) Patent Application Publication
(10) Pub. No.: US 2020/0165844 A1
(43) Pub. Date: May 28, 2020

(54) LATCH ASSEMBLY WITH LATCH HOUSING MOTOR SEAT WITH RESILIENT MOTOR RETENTION FEATURE

(71) Applicant: Magna Closures Inc., Newmarket (CA)

(72) Inventor: Franco Giovanni Ottino, San Giuliano Terme (IT)

(21) Appl. No.: 16/695,561

(22) Filed: Nov. 26, 2019

Related U.S. Application Data
(60) Provisional application No. 62/772,294, filed on Nov. 28, 2018.

(51) Int. Cl. E05B 79/08; E05B 85/02; E05B 77/38

(52) U.S. Cl. CPC E05B 79/08; E05B 77/38; E05B 85/02

(57) ABSTRACT

A latch assembly for a vehicle closure panel is provided. The latch assembly includes a housing having a motor seat within an internal cavity sized for receipt of a motor for the latch assembly. A cover is attached to the housing to enclose at least a portion of the internal cavity and to secure the motor in the motor seat. The housing and the cover may include a resilient feature that deflects to secure the motor within the motor seat. The resilient feature is integrally formed in the housing and the cover. An upper wall portion of the cover may deflect when the motor is secured. An upstanding wall portion of the motor seat may deflect when the motor is secured. A plurality of ribs extending from the upper wall portion may deflect when the motor is secured.

### CROSS-REFERENCES TO RELATED APPLICATIONS

This patent application claims priority to U.S. Provisional Patent Application Ser. No. 62/772,294 filed Nov. 28, 2018 which is incorporated herein by reference in its entirety.

### FIELD

The present disclosure relates generally to latch assemblies of vehicle closure panels, and more particularly to latch assemblies having a motor seat with resilient retention features.

### BACKGROUND

This section provides background information related to the present disclosure that is not necessarily prior art.

Vehicle doors are typically equipped with a latch assembly configured to allow selective opening and closing of the door. Latch assemblies commonly have multiple components assembled to one another, such as a housing and cover having peripheries brought into mating abutment with one another, as well as a multiple functional internal components contained within the housing/cover assembly. Further, openings are typically formed in the housing and/or cover to allow for the through passage of one or more members, such as electrical wires or Bowden cables for example, for operable connection to one or more of the functional internal components.

One internal component disposed within the housing or cover is an electric motor that is used to actuate other internal components such as ratchets or pawls. The motor may be attached to a gear mechanism that interfaces with another gear that is attached to the ratchet or pawl to cause the ratchet or pawl to pivot and operate the latch assembly. One problem that can arise is that the motor may shift within the housing relative to its intended position, which can lead to malfunctioning with the various geared connections.

One solution to this problem has been the introduction of rubber bumpers or stabilizers within the housing at the location of the motor, where the rubber may be compressed to hold the motor in place via the compressive forces between the rubber and the motor. However, the cover or housing is typically an injection molded plastic part, requiring an additional step of applying the extra rubber component to the housing or cover.

### SUMMARY

This section provides a general summary of the disclosure and is not intended to be considered a complete and comprehensive listing of the disclosure's full scope or all of its aspects, advantages, objectives and/or features.

It is an object of the present disclosure to provide a housing or cover that can reliably retain the motor of the latch assembly in place, thereby preventing disengagement between the gear mechanisms within the latch assembly.

It is a further object of the present disclosure to provide a latch assembly having a cover that may retain the motor without requiring the addition of extra rubber material applied after the cover or housing has been molded.

It is a further object of the present disclosure to provide a latch assembly having a cover or housing with a flexible portion that allows an interference fit between the cover or housing and the motor.

It is a further object of the present disclosure to provide a latch assembly that is economical in manufacture, shipping and assembly.

It is a further object of the present disclosure to provide a latch assembly that exhibits a long and useful life.

In accordance with these objectives, as well as others, which will be appreciated by those possessing ordinary skill in the art, the present disclosure is directed to providing a latch assembly for a vehicle closure panel. The latch assembly includes a housing having an internal cavity configured for receipt of internal latch components and a cover attached to said housing to enclose at least a portion of said internal cavity. The latch assembly further includes a motor disposed within the internal cavity of the housing and the cover and a motor seat defined by the housing, wherein the motor is retained in the motor seat.

The latch assembly further includes a plurality of ribs projecting from the cover toward the motor and the housing. The latch assembly also includes a resilient feature defined by at least one of the housing and the cover, the resilient feature configured to deflect when the motor is retained in the motor seat and the cover is attached to the housing.

In accordance with a further aspect of the disclosure, a method for assembling a latch assembly is provided. The method includes providing a housing having a motor seat and inserting a motor into the motor seat. The method further includes attaching a cover to the housing and defining a cavity therein and securing the motor within the motor seat and the cavity in response to attaching the cover to the housing. The method also includes deflecting a resilient feature integrally formed in at least one of the housing and the cover when securing the motor within the motor seat. In accordance with yet another aspect, there is provided a housing assembly including a housing having an internal cavity configured for receipt of a component, a cover attached to the housing to enclose at least a portion of the internal cavity, a component disposed within the internal cavity of the housing and the cover, a component seat defined by the housing, such that the component is retained in the component seat, and a resilient feature defined by at least one of the housing and the cover, the resilient feature configured to deflect when the component is retained in the motor seat and the cover is attached to the housing.

Further areas of applicability will become apparent from the detailed description provided herein. The description and specific examples provided in this summary are intended for purposes of illustration only and are not intended to limit the scope of the present disclosure.

### BRIEF DESCRIPTION OF THE DRAWINGS

Other aspects and advantages of the present non-limiting embodiments will be readily appreciated, as the same becomes better understood by reference to the following detailed description and appended claims when considered in connection with the accompanying drawings, wherein:

FIG. 1 is a partial perspective view of a motor vehicle equipped with a pivotal passenger-entry door having a door handle operably interconnected to a latch assembly constructed in accordance with and embodying the teachings of the present disclosure;

FIG. 2 is a plan view of the latch shown in FIG. 1 with a portion of a housing of the latch omitted and showing a secondary pawl locking position;

FIG. 3 is a plan view of the latch shown in FIG. 2 in a secondary pawl release position and illustrating a motor with a rotational screw gear;

FIGS. 4A-4C illustrate the motor retained within the housing and the cover and retention features for securing the motor;

FIGS. 5A and 5B are schematic views illustrating the motor being installed into a motor seat on the housing and a retention feature to secure the motor;

FIGS. 6A and 6B are schematic views illustrating another aspect of the retention feature on the housing when the motor is installed in a motor seat;

FIGS. 7A and 7B are schematic views illustrating another aspect of the retention feature on the housing when the motor is installed in a motor seat;

FIGS. 8A and 8B are schematic views illustrating another retention feature in the form of ribs extending from the cover and the cover being installed to secure the motor;

FIGS. 9A and 9B are schematic views illustrating another aspect of the retention feature in the form of ribs on the cover and the cover being installed to secure the motor;

FIGS. 10A and 10B are schematic views illustrating another aspect of the retention feature in the form of ribs on the cover

FIG. 11 illustrates a method for assembling a latch assembly, in accordance with an illustrative embodiment;

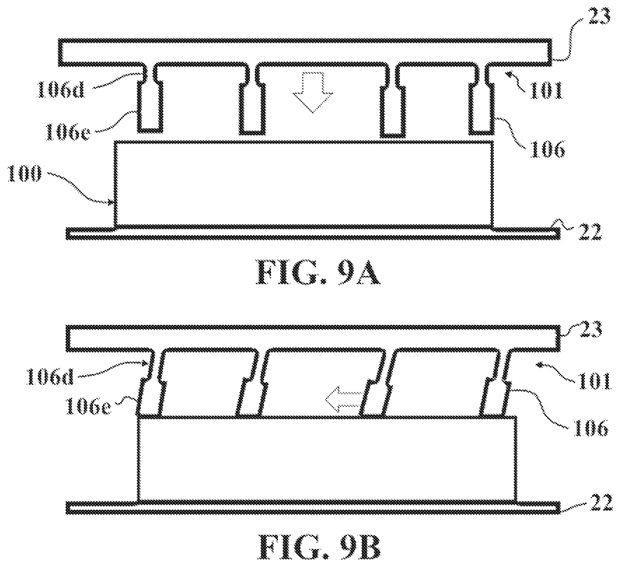

FIG. 12. and FIG. 13 illustrate perspective views of a latch assembly in an assembled and disassembled state accordance with another illustrative embodiment including resilient features in a cover and housing portion;

FIG. 14 illustrates an exploded bottom perspective view of the latch assembly for FIG. 13, illustrating a plurality of ribs, in accordance with an illustrative embodiment;

FIG. 15 illustrates a close up view of the ribs of FIG. 14;

FIG. 16 illustrates an top perspective view of the latch assembly for FIG. 13, illustrating a motor seat with resilient feature, in accordance with an illustrative embodiment;

FIG. 17 illustrates a close up view of the motor seat of FIG. 14; and

FIG. 18 illustrates a cross-sectional view of the cover and housing of the latch assembly of FIG. 13 showing the deflections of the resilient features, in accordance with an illustrative embodiment.

Corresponding reference numerals indicate corresponding components throughout the several views of the drawings, unless otherwise indicated.

### DETAILED DESCRIPTION OF THE EXAMPLE EMBODIMENTS

In general, example embodiments of lockable release cable assemblies of the type configured for use with motor vehicle closure systems, constructed in accordance with the teachings of the present disclosure, will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

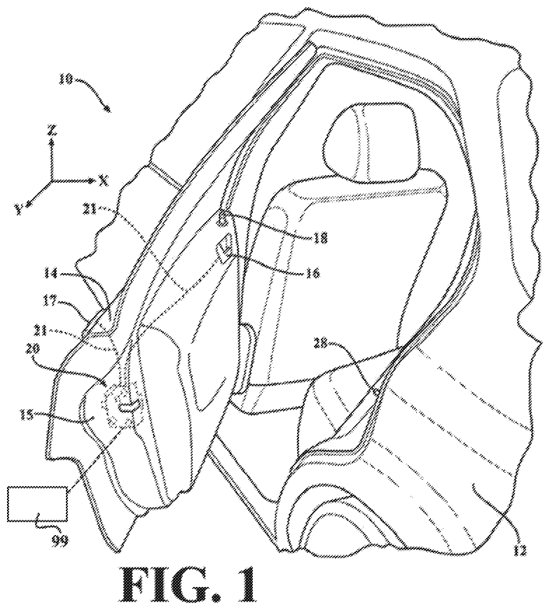

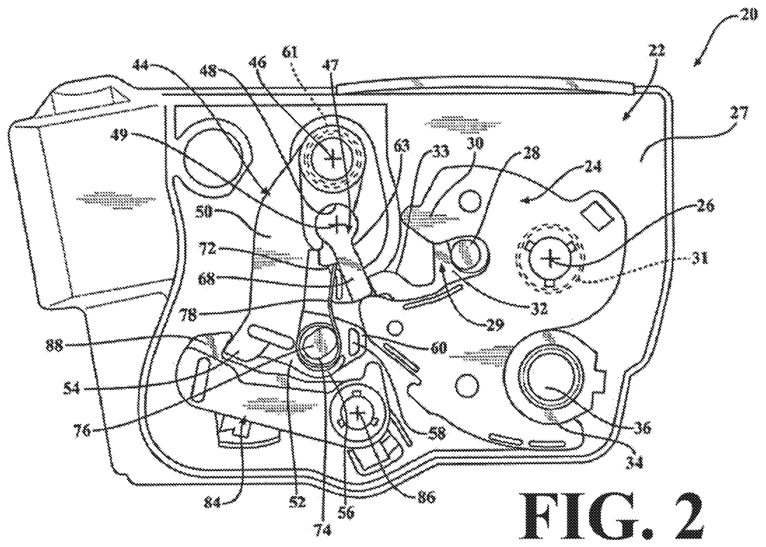

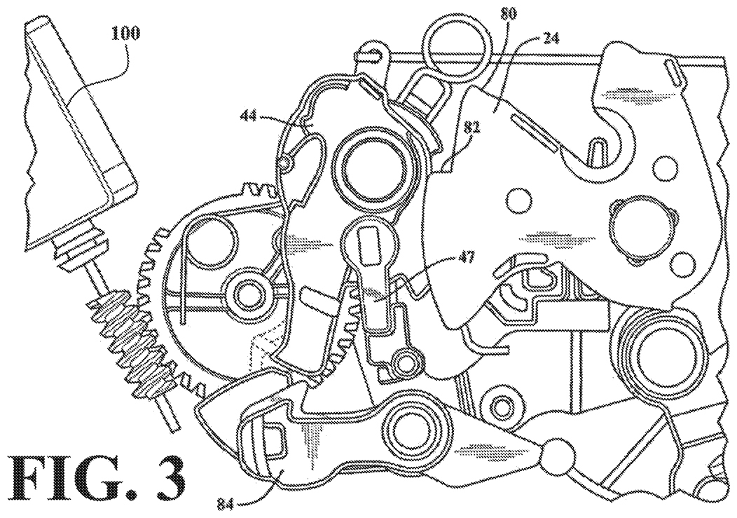

FIG. 1 is a perspective view of a vehicle 10 that includes a vehicle body 12 and at least one vehicle closure panel, shown as a vehicle door 14, by way of example and without limitation. The vehicle door 14 includes an edge face 15, inside and outside door handles 16, 17, a lock knob 18, with at least one hinge pivotally fixing the door 14 to the vehicle body 12. A latch assembly 20 is positioned or sealing affixed against an inner surface of the edge face 15. The latch assembly 20 includes a latch mechanism having a pivotal latch (i.e. ratchet) member 24 (FIGS. 2 and 3) that is releasably engageable with a striker 28 mounted on the vehicle body 12 to releasably hold the vehicle door 14 in a closed position. The lock knob 18 (optional) is shown and provides a visual indication of the lock state of the latch assembly 20 and may be operable to change the lock state between an unlocked state and a locked state. At least one of the handles 16, 17 is operably connected to the latch assembly 20 via a wire or release cable 21, such as a Bowden cable, by way of example and without limitation, for facilitating actuation of latch assembly 20 via intended (selective) operation of the handles 16, 17. For example, release cable 21 may be another type of cable, such as a cinch cable, or a lock or unlock cable, or the like. Specifically, the release cable 21 operably connects one of handles 16, 17 to the functionally moveable latch member release component 24 of the latch assembly 20 for opening or unlatching the latch assembly 20 (i.e. for releasing striker 28 from latched engagement with the latch member 24) to open the vehicle door 14.

As is detailed hereafter, the latch assembly 20 is constructed and otherwise configured to retain a component such as for example motor 100 within a cavity 27 of an assembly of a housing 22 and a cover 23 of the latch assembly. Additional structure may be secured to the assembly of the housing 22 and the cover 23 to define the overall latch assembly. Accordingly, the latch assembly 20 is able to function as intended, for an extended useful life, without concern of malfunction resulting from the motor 100 shifting or moving within the cavity 27.

In general, the closure panel 14 (e.g. occupant ingress or egress controlling panels such as, but not limited to, vehicle doors and lift gates/hatches) is connected to vehicle body 12 via one or more hinges (e.g. for retaining closure panel 14). Closure panel 14 can be referred to as a partition or door, typically hinged, but sometimes attached by other mechanisms such as tracks, in front of an opening which is used for entering and exiting vehicle 10 interior by people and/or cargo. It is also recognized that closure panel 14 can be used as an access panel for vehicle systems such as engine compartments and traditional trunk compartments of automotive type vehicles 10. It is to be recognized that the hinge(s) can be configured as a biased hinge that is operable to bias closure panel 14 toward the open position and/or toward the closed position, as desired. The vehicle body 12 can include the mating latch component 28 (e.g. striker) mounted thereon for coupling with a respective functional latching component 24 (i.e. the ratchet) of latch assembly 20 mounted on closure panel 14. Alternatively, latch assembly 20 can be mounted on vehicle body 12 and the mating latch component 28 can be mounted on the closure panel 14 (not shown, but will be readily understood by one skilled in the art).

Movement of the closure panel 14 (e.g. between the open and closed positions) can be electronically and/or manually operated, where power assisted closure panels 14 can be found on minivans, high-end cars, or sport utility vehicles (SUVs) and the like. As such, it is recognized that movement of the closure panel 14 can be manual or power assisted during intended operation of closure panel 14, for example, between fully closed (e.g. locked or latched) and fully open positions (e.g. unlocked or unlatched); between locked/latched and partially open positions (e.g. unlocked or unlatched); and/or between partially open (e.g. unlocked or unlatched) and fully open positions (e.g. unlocked or unlatched). It is recognized that the partially open position of the closure panel 14 can also include a secondary lock position.

In terms of vehicles 10, closure panel 14 may be a driver/passenger door, a lift gate, or it may be some other kind of closure panel 14, such as an upward-swinging vehicle door (i.e. what is sometimes referred to as a gull-wing door) or a conventional type of door that is hinged at a front-facing or back-facing edge of the door, and so allows the door to swing (or slide) away from (or toward) the opening in body 12 of vehicle 10. Also contemplated are sliding door embodiments of closure panel 14 and canopy door embodiments of closure panel 14, such that sliding doors can be a type of door that open by sliding horizontally or vertically, whereby the door is either mounted on, or suspended from a track that provides for a larger opening. Canopy doors are a type of door that sit on top of the vehicle and lift up in some way, to provide access for vehicle passengers via the opening (e.g. car canopy, aircraft canopy, etc.). Canopy doors can be connected (e.g. hinged at a defined pivot axis and/or connected for travel along a track) to the body 12 of the vehicle 10 at the front, side or back of the door, as the application permits. It is recognized that body 12 can be represented as a body panel of vehicle 10, a frame of vehicle 10, and/or a combination frame and body panel assembly, as desired.

With regard to the latch assembly 20, FIG. 2 is a plan view showing some of the functional internal latch components of one possible embodiment of latch assembly 20 in accordance with the disclosure, while those possessing ordinary skill in the art of vehicle latches will readily appreciated other latch arrangements. The latch assembly 20 includes the housing 22 bounding, at least in part, the internal cavity 27 in which the primary ratchet 24 (which may, for convenience, be referred to simply as the ratchet 24) is pivotally mounted via a primary ratchet pin joint for rotation about a primary ratchet pivot axis 26 mounted in the housing 22. The ratchet 24 pivots between a fully closed position (FIG. 2) wherein the striker 28 is captured in a slot 29 by a hook 30 of the ratchet 24, and an open position (FIG. 3) wherein the striker 28 is not trapped by the hook 30 and is free to move out of the slot 29 presented by the ratchet 24. In the view shown in FIG. 2 the ratchet 24 rotates clockwise to move from the closed position to the open position.

The ratchet 24 is biased towards the open position via a ratchet biasing member 31. The biasing member 31 may be any suitable type of biasing member, such as, for example, a torsion spring. A striker bumper 32 is mounted in the housing 22 (underneath the ratchet 24) to cushion against the striker force of impact and a ratchet bumper 34 is also mounted about a post 36 provided in the housing 22 to cushion against the ratchet force of impact.

An auxiliary ratchet 44 is also pivotally mounted in the internal cavity 27 of housing 22 via an auxiliary ratchet pin joint 46 for movement about an auxiliary ratchet pivot axis 46. A primary pawl 47 is pivotally mounted to the auxiliary ratchet 44 via a primary pawl pin joint 49 for movement about a primary pawl pivot axis. The auxiliary ratchet 44 is movable between a primary pawl enabling position (FIG. 2) and a primary pawl disabling position (FIG. 3). In the primary pawl enabling position, the auxiliary ratchet 44 permits the primary pawl 47 to move to a ratchet locking position to hold the ratchet 24 in the closed position, as shown in FIG. 2. In the primary pawl disabling position (FIG. 3) the auxiliary ratchet 44 prevents movement of the primary pawl 47 to the ratchet locking position, and instead holds the primary pawl 47 in a ratchet release position, as discussed in greater detail below. In the view shown in FIG. 2, the auxiliary ratchet 44 rotates clockwise to reach the primary pawl disabling position.

The auxiliary ratchet 44 includes a cylindrical bore 48 that receives a cylindrical stub of the primary pawl 47 for pivotally mounting the primary pawl 47 into the bore 48, thereby forming pin joint 49 of the auxiliary ratchet 44. This provides a simple means for mounting the primary pawl 47, which may be formed from a simple stamped or sintered metal piece.

The auxiliary ratchet 44 also includes a leg 50 that optionally, as shown in FIG. 2, terminates in an anvil 52 having a check shoulder 54 and a cam lip 56. The auxiliary ratchet 44 may be encapsulated with an elastomeric material and features an optional hollow 58 (FIG. 2) so as to provide an elastically deformable band 60 for contacting and absorbing impact against the ratchet 24.

An auxiliary ratchet biasing member 61 located on the opposing side of the housing 22 biases the auxiliary ratchet 44 to the primary pawl disabling position. Only the hub portion of the auxiliary ratchet biasing member 61 is shown in FIG. 2, (and is shown in stippled lines), for simplicity. The biasing member 61 may include a first tang (not shown) that abuts a capstan of pin joint 46 and a second tang which cooperates with a fork (not shown) in the auxiliary ratchet 44 via a slot (not shown) formed in the housing 22.

Referring back to FIG. 2, the primary pawl 47 includes a check arm 68. In the ratchet locking position the check arm 68 stops the ratchet 24 from opening by abutting contact with a surface of the ratchet 24. The primary pawl 47 rotates clockwise to move to the ratchet release position.

The angular sweep of the check arm 68 is limited on one side by an edge 63 in the auxiliary ratchet 44 and on the other side by the auxiliary ratchet leg 50. A proboscis bumper 72 formed from an encapsulation of the primary pawl 47 may be provided to cushion impact of check arm 68 against the auxiliary ratchet leg 50. An extension 33 of the striker bumper 32 may be provided to reduce or cushion impact of check arm 68 against the auxiliary ratchet edge 63.

The primary pawl 47 is biased towards the ratchet locking position by a primary pawl biasing member 74 wrapped around a post 76 provided in the anvil 52 of the auxiliary ratchet 44. One tang (not visible in FIG. 2) of the biasing member 74 rides against the auxiliary ratchet leg 50, and another tang 78 abuts the check arm 68 of the primary pawl 47. As the biasing member 74 is mounted to the auxiliary ratchet 44 rather than the fixed housing 22, the biasing forces on the primary pawl 47 will not vary appreciably as the auxiliary ratchet 44 rotates. In embodiments wherein the post 76 is not provided, the biasing member 74 may be provided on the housing 22 or at some other location on the auxiliary ratchet 44.

As shown in FIG. 3, ratchet 24 features primary and secondary locking surfaces 80 and 82 that interact with the check arm 68 (FIG. 2) of the primary pawl 47. The primary locking surface 80 provides a fully closed position for the ratchet 24 in which the striker 28 is securely ensconced in the slot 29 of the ratchet 24 such that the vehicle door 14 is completely closed and the door seals are compressed. The secondary locking surface 82 provides a partially closed and locked position of the ratchet 24 wherein the striker 28 is loosely secured in the slot 29 of the ratchet 24 such that the vehicle door 14 is locked but not completely closed against the door seals.

A secondary pawl 84 is pivotally mounted in the housing 22 via a secondary pawl pin joint for movement about a secondary pawl pivot axis 86 for movement between an auxiliary ratchet holding position where the secondary pawl 84 holds the auxiliary ratchet 44 in the primary pawl enabling position, as shown in FIG. 2, and an auxiliary ratchet release position in which the secondary pawl 84 permits the auxiliary ratchet 44 to move to the primary pawl disabling position, as shown in FIG. 3. In the view shown in FIG. 2 the secondary pawl 84 rotates counterclockwise to reach the auxiliary ratchet release position. The secondary pawl 84 includes a hook shoulder 88 for engaging the auxiliary ratchet check shoulder 54. The secondary pawl 84 is biased towards the auxiliary ratchet holding position by a secondary pawl biasing member. The secondary pawl biasing member may be any suitable type of biasing member, such as, for example, a torsion spring. The motor 100 is also shown in FIG. 3 and may a typical motor for use in vehicle latch assemblies.

In one aspect, the latch assembly 20 may be in the form of a “smart-latch” being in communication with a controller 99. The controller 99 may be one of more components or modules configured to operate the latch assembly 20 electronically in response to a signal received from sensors or other remote command devices. Accordingly, the latch assembly 20 may be actuated by the controller 99 to operate the motor 100 in response to receiving one or more signals.

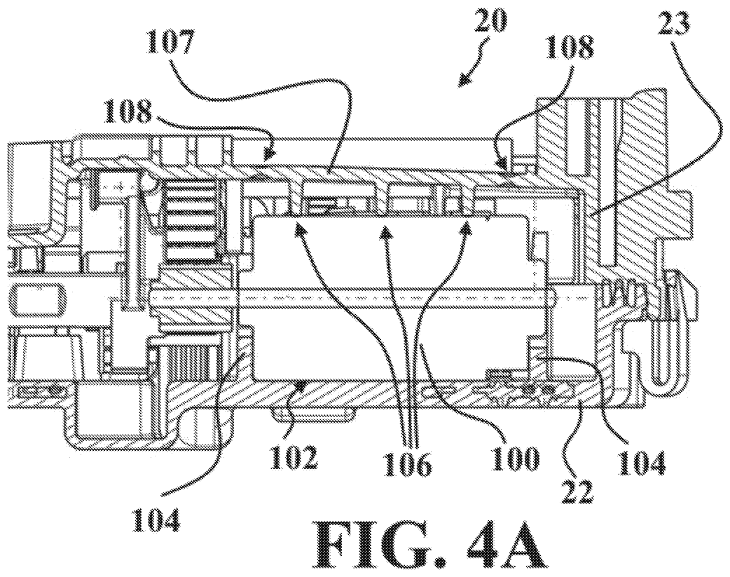

Referring to FIGS. 4A-C, the housing 22 and cover 23 of the latch assembly 20 are shown in an assembled state with the electric motor 100 disposed within the cavity 27 defined by the housing 22 and cover 23. The motor 100 is disposed within a motor seat 102 formed in the housing 22, and held in place by the cover 23 which is placed over the motor 100 when the motor 100 is disposed within the motor seat 102. The housing 22 and cover 23 may be assembled using a snap-fit or via fasteners, or via other fixing mechanisms.

The motor seat 102 may include a plurality of upstanding wall portions 104 that project upward from a bottom surface of the housing 22. The wall portions 104 may be sized and arranged to correspond to the size and shape of the motor 100. The wall portions 104 may be arranged to flex in response to insertion of the motor 100 into the motor seat 102 to hold the motor 100 in place via interference fit, as further described below. The wall portions 104 need not necessarily surround the entire motor 100 or correspond precisely to the shape of the motor 100.

The cover 23 may include a plurality of ribs 106 that project downwardly from an upper wall portion 107 of the cover 23. The ribs 106 are sized and arranged to project at a distance that generally corresponds to the shape of the motor 100 when the cover 23 is attached to the housing 22 and the motor 100 is disposed in the motor seat 102 therein. The ribs 106 may be spaced apart to contact different sections of the motor 100. The ribs 106 may be arranged to be flexible and to flex in response to contacting the motor 100 when the cover 23 is installed over the motor 100 that is placed within the motor seat 102. In this approach, the ribs 106 and motor 100 may cooperate to define an interference fit, as further described below.

It will be appreciated that in the above description referring to the sizes and shapes being arranged to generally correspond, that for instances of an interference fit the sizes of the respective components may be smaller or larger that the component or portion with which the interference is created. A skilled artisan will understand that a substantial difference in size and shape between components in an interference fit may make an interference fit difficult, and that the intended purpose of the interference fit is for there to be a sufficient difference in size and shape to allow for the interference fit, and that an exact correspondence in size and shape between components would not create the intended interference fit.

The upstanding walls 104 of the motor seat 102 on the housing 22 and/or the ribs 106 and upper wall 107 of the cover 23, or other retention features described herein, may be referred to generally as retention features 101 or resilient features 101, as they may each be arranged to deflect and retain the motor 100, as further described below. The above described interference fit capabilities between the motor 100 and the retention features 101 may be applied to the ribs 106, the upper wall 107, or the walls 104, or the interference fit may be applied to both the ribs 106 and the walls 104, or other portions of the cover 23 or housing 22. In one aspect, at least one of the retention features 101 is made to be flexible and resilient and capable of engaging the motor 100 in an interference fit.

The retention features 101 may be integrally formed or molded with housing 22 and/or the cover 23, such that the retention features 101 do not have to be attached after the molding process. Rather, the retention features 101 are formed during the molding process that creates the housing 22 and/or cover 23.

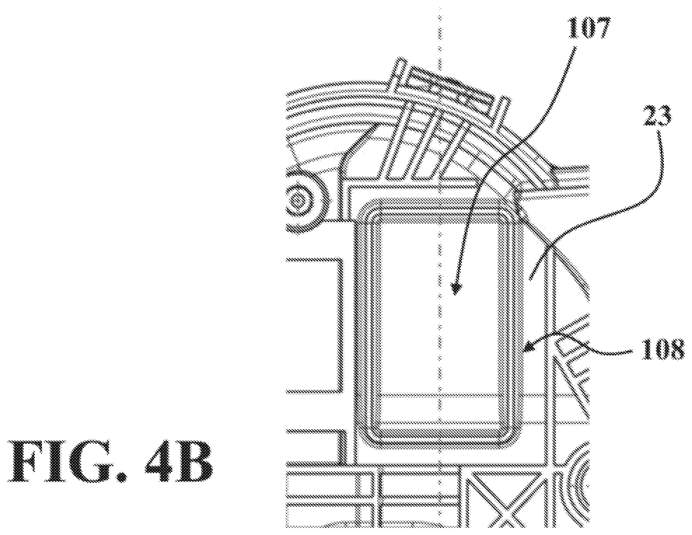

With reference now to FIGS. 5A-B, in one aspect the motor seat 102 includes two of the upstanding walls 104. The walls 104 project upward from a base/bottom portion 102a of the motor seat 102, which may be the bottom wall of the housing 22. The walls 104 may include a lower portion 104a having a first thickness, an upper portion 104b having a second thickness (which may be the same, smaller, or larger than the first thickness), and a middle portion 104c having a third thickness or reduced thickness, which is smaller than both the first and second thicknesses of the bottom portion 104a and upper portion 140b, respectively.

The middle portion 104c may also be referred to as a flexible portion or resilient portion. The middle portion 104c is sized and arranged to permit the wall 104 to flex or bend at the middle portion 104c due to the reduced thickness relative to the remainder of the wall. Accordingly, when the motor 100 is inserted into the motor seat 102 of the housing 22, the walls 104 will flex in response, providing an inward retaining force on the motor 100. Thus, the motor 100 may be held in place on the housing 22 at the motor seat 102 via an interference fit.

The installation of the motor 100 is illustrated in FIGS. 5A-B, with the motor 100 being shown above the motor seat 102 in an uninstalled position in FIG. 5A, where the walls 104 are in a nominal position. FIG. 5B illustrates the motor 100 within the motor seat, with the walls 104 having flexed. Similar installations of the motor 100 are shown in additional figures.

The motor seat 102 may include additional walls 104 that are not shown in FIG. 5, for example walls 104 that are in front of and behind the motor 100 shown in FIG. 5. The walls 104 may therefore be arranged to surround the motor 100 to retain the motor 100 in the above described interference fit. The downward force exerted on the motor 100 may be provided by the ribs 106 that project downwardly from the cover 23, which are described in further detail below. The cover 23 will maintain a compressive downward force on the motor 100 to retain the motor 100 in the motor seat 102. The reduced thickness is illustrated in the form of a recess on an outer surface of the walls 104, but it will be appreciated that the recess may be on the inner surface or on both surfaces.

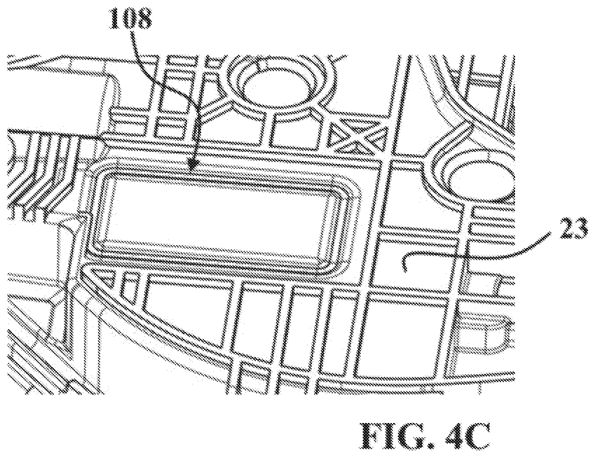

With reference to FIGS. 6A-B, another aspect of the motor seat 102 is illustrated. In this aspect, the walls 104 are sized and arranged to include a lower portion 104d and an upper portion 104e. The lower portion 104d may have a reduced thickness relative to the upper portion 104e. Accordingly, when the motor 100 is placed into the motor seat 102, the walls 104 may flex outward at the lower portion 104d due to the reduced thickness. In this approach, the reduced thickness of the lower portion 104d is disposed at the interface between the walls 104 and the bottom portion 102a of the motor seat. The reduced thickness is illustrated in the form of a recess on an outer surface of the walls 104, but it will be appreciated that the recess may be on the inner surface or on both surfaces.

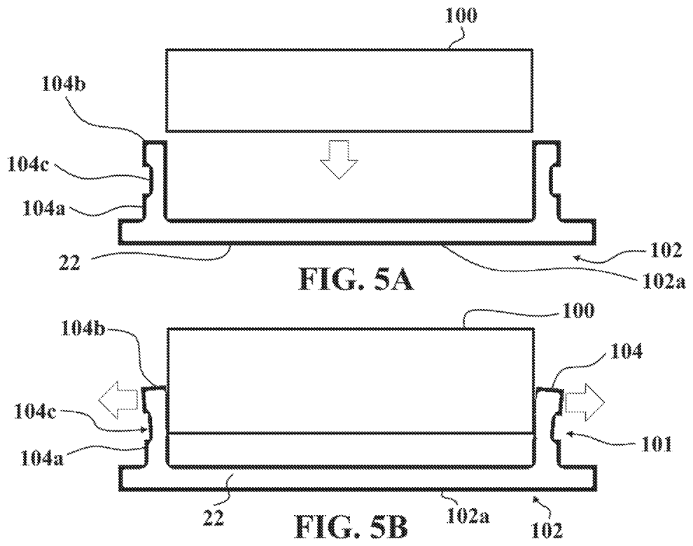

With reference to FIGS. 7A-B, another aspect of the motor seat 102 is illustrated. In this aspect, the bottom portion 102a of the motor seat 102, which may be a portion of the housing 22, includes a recess 102b disposed at the interface between the walls 104 and the bottom portion 102a. The recesses 102b may be disposed inwardly relative to the walls 104. The recesses 102b create a reduced thickness area of the bottom portion 102a, allowing the bottom portion 102a to flex relative the wall material of the housing 22.

In this approach, when the motor 100 is inserted downwardly into the motor seat 102 and within the walls 104, the walls 104 may flex outwardly to retain the motor 100 in an interference fit. The material of the housing 22 may deflect downwardly as the walls 104 pivot outwardly. The recesses 102b and the reduced thickness allow the bottom portion 102a to be flexible to accommodate the interference fit. The reduced thickness is illustrated in the form of a recess on an upper surface of the bottom portion 102a, but it will be appreciated that the recess may be on the lower surface or on both surfaces.

Each of the above described arrangements that create reduced thickness flexible portions of the motor seat 102 permit the motor 100 to be held in an interference fit in response to the walls 104 being allowed to flex outward in response to insertion of the motor 100 in a downward direction. To assist in maintaining the interference fit, the motor 100 may be held in place with a downward force applied to the motor 100. The downward force may be applied by the cover 23, which is installed over the motor 100 and the housing 22.

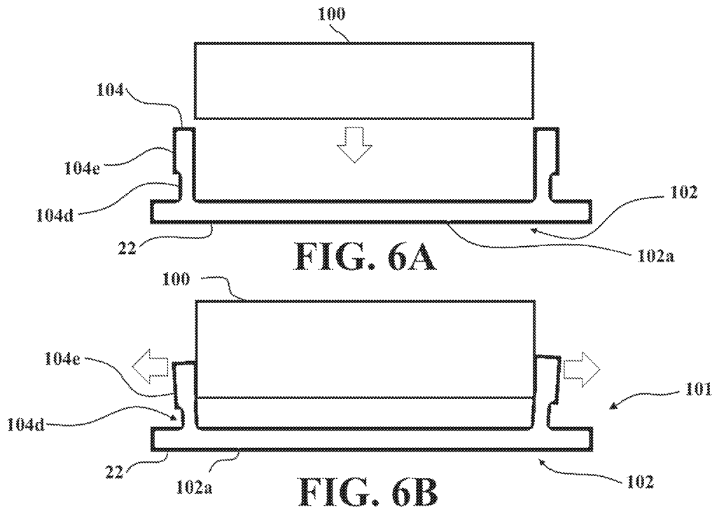

With reference back to FIGS. 4A-C, and with further reference to FIGS. 8A-B, the cover 23 may include the downwardly extending ribs 106 that extend from an upper surface or wall of the cover 23. The downwardly extending ribs 106 may contact the top of the motor 100 to provide the downward force on the motor 100 to maintain the motor 100 in an interference fit with the motor seat 102. The walls 104 are not illustrated in FIG. 8, but it will be appreciated that the previously described walls 104 and motor seat 102 of the housing 22 may be applied to these descriptions of the cover 23.

The ribs 106 and/or the cover 23 may include flexible portions, similar to the flexibility of the walls 104 and/or motor seat 102 described above. The ribs 106 may be referred to as compressive ribs, where the ribs 106 may also be compressed and/deflected when the cover 23 is installed over the motor 100 and pressed down on the motor 100. By allowing the ribs 106 to be compressed, the reaction force from the motor 100 in response to compression may be reduced, providing a more accommodating installation for the motor 100 and allowing the cover 23 to be installed. Put another way, the ribs 106 being compressible provides a further interference fit type retention of the motor 100 relative to the cover 23. The housing 22 may thereby provide horizontal retention of the motor 100 via the walls 104, while the cover 23 and housing 22 combine to provide vertical retention of the motor via the bottom portion 102a of the motor seat 102 and the compressive ribs 106 of the cover 23.

With reference to FIGS. 8A-B, one aspect of the system includes the ribs 106, which have a top portion 106a, a bottom portion 106b, and a middle portion 106c. The middle portion 106c may have a reduced thickness relative to the top and bottom portions 106a, 106b. The reduced thickness permits the ribs 106 to flex or bend at the middle portion 106c, such that the bottom portion 106b may be deflected relative to the top portion 106a. It will be appreciated that the reduced thickness may be formed on one or both sides of the ribs 106.

FIG. 8A illustrates the ribs 106 in a nominal state extending downwardly from the top of the cover 23 prior to contacting the motor 100. FIG. 8B illustrates the ribs 106 in a compressed or deflected state relative to the nominal position after being pressed downwardly on the motor 100. The interference between the ribs 106 and the top of the motor 100 causes the ribs 106 to deflect to the side and/or become vertically compressed relative to the nominal state. FIG. 8B illustrates all of the ribs 106 deflecting in the same direction. However, it will be appreciated that some of the ribs 106 may deflect in one direction and others of the ribs 106 may deflect in the opposite direction.

The ribs 106 are integrally formed with the cover 23, and may be formed along with the remainder of the cover 23 during the molding process of the cover 23. The ribs 106 may be molded with the cover 23 into the nominal state described above. However, in another approach, the ribs 106 may be molded to a different nominal state, such as a nominal state in which the ribs 106 are already in a partially deflected state relative to a normal/perpendicular direction from the top of the cover 23. For example, the ribs 106 may be oriented at an oblique angle relative to the top of the cover 23. In this approach, the direction that the ribs 106 will deflect in response to contacting the motor 100 may be controlled.

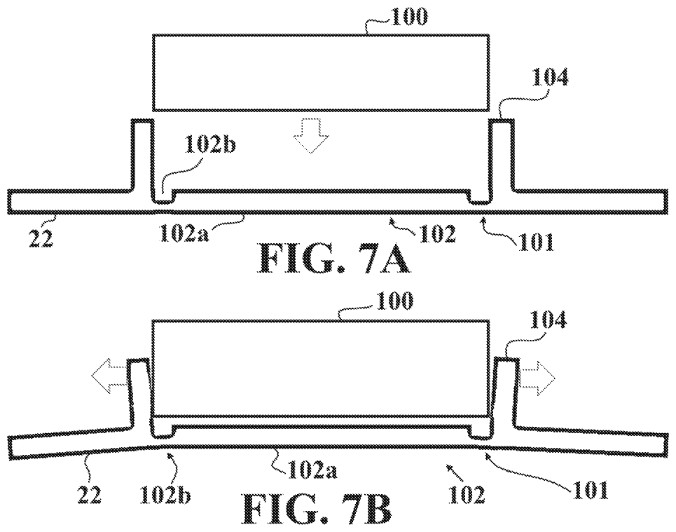

FIGS. 9A-B illustrates another aspect of the ribs 106. In FIG. 9A, the ribs 106 may be sized and arranged to include neck portion 106d and a head portion 106e, with the neck portion 106d having a reduced thickness relative to the head portion 106e. The reduced thickness may be disposed at the interface between the ribs 106 and the top of the cover 23. When the ribs 106 are pressed down on the motor 100, the ribs 106 will flex and bend at the interface between the ribs 106 and the cover 23 based on the reduced thickness of the neck portion 106d. Similar to the above, the ribs 106 may be molded into a nominal position that is normal/perpendicular to the cover 23, or they may be molded into a partially deflected state at an oblique angle relative to the cover 23. The ribs 106 may deflect in either direction when coming into contact when the ribs 106 are arranged normal to the top of the cover 23. When the ribs 106 are angled in the nominal state, the ribs 106 will tend to deflect in the direction that they are angled. It will be appreciated that the reduced thickness may be formed on one or both sides of the ribs 106.

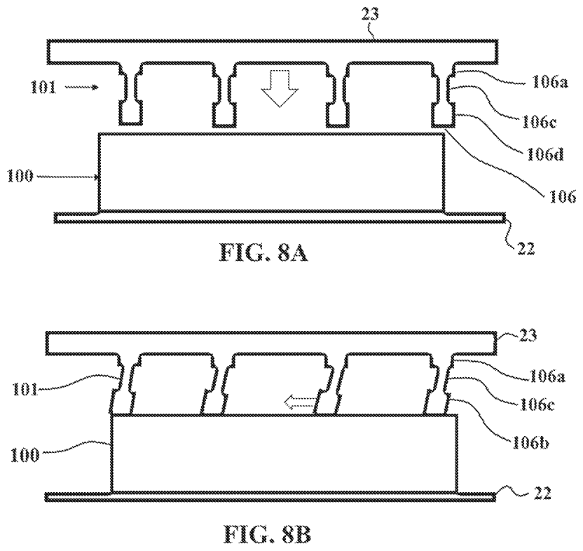

FIGS. 10A-B illustrate another aspect of the cover 23 and the ribs 106 that may be used to retain the motor 100 in the motor seat 102. In this aspect, the ribs 106 may be generally rigid relative to the cover 23, rather than having a reduced thickness flexible portion as described above. The ribs 106 may have a generally constant thickness along their length.

The cover 23 may include a resilient portion 108 (also shown in FIGS. 4A-C) formed in an upper wall 107 of the cover 23. The resilient portion 108 may be in the form of a reduced thickness portion, which may be formed by thinning out the area around the upper wall portion 107 of the cover 23 around the ribs 106. The resilient portion 108 may thereby be disposed outboard of the ribs 106. The reduced thickness may be formed by forming a recess in the upper and lower surfaces of the upper wall 107 of the cover 23. Alternatively, a recess may be formed in either the upper surface of the lower surface of the upper wall 107 of the cover 23. In either case, the thickness of the upper wall 107 of the cover 23 is reduced, and can thereby provide a flexible and resilient feature that will flex and bend in response to a force exerted thereon.

FIG. 10A illustrates the cover 23 in a nominal state, with the ribs 106 extending from the wall portion 107, which may also be referred to as rib support member 109. The rib support member 109 is a portion of the upper wall portion 107 of the cover 23, and is defined between the resilient portions 108. The rib support member 109 may be generally aligned with the adjacent portions of the cover 23 in the nominal state as shown in FIG. 10A.

When the cover 23 is placed over the motor 100 and pressed down on the motor 100, the ribs 106 will contact the motor 100. Pressing down on the motor 100 will cause a reaction force on the ribs 106 and the rib support member 109. Accordingly, the ribs 106 and the rib support member 109 will shift upward, and the resilient portions 108 will flex to accommodate the upward movement of the ribs 106 and the support member 109. The flexible and resilient nature of the resilient portions 108 will cause the ribs 106 to continue to exert a downward force on the motor 100 when the ribs 106 and support member 109 are displaced upward relative to the remainder of the cover 23.

In this approach, the ribs 106 will generally not flex in response to contacting the motor 100. However, this arrangement still provides an interference fit with the motor 100 due to the contact between the ribs 106 and motor 100 causing the rib support portion 109 to shift upward and provide a downward force on the motor 100. The amount of interference between the ribs 106 and the motor 100 will affect the amount that the support portion 109 will shift or deflect upward and the amount that the resilient portions 108 will flex. A small amount of interference will result in a smaller downward force applied by the ribs 106, and a larger amount of interference will result in a greater downward force applied by the ribs.

Thus, in view of the above aspects of the cover 23 with integrally formed ribs 106 and the housing 22 with integrally formed walls 104 that define a motor seat 102, the housing 22 and cover 23 may provide a robust and efficient manner for retaining the motor 100 within the housing 22 and cover 23 when assembled. This approach provides for flexible and resilient portions and retention features 101 in one or both of the housing 22 and cover 23 that will hold the motor 100 in place by interference fit, and does not require the inclusion of additional rubber components applied, for example glued, to the interior surfaces of the housing 22 and cover 23 after they have been molded.

The resilient features 101 described above for the cover 23 and housing 22 may work together to retain the motor 100, but the motor 100 may also be held in place by resilient features 101 in only one of the housing 22 or the cover 23. For example, the housing 22 may include the walls 104 that define the motor seat 102, but the walls 104 may be sized such that they will not deflect when the motor 100 is placed within the motor seat 102. The resilient features 101 of the cover 23 may then be used to provide the interference type fit for the motor 100, and the force applied by the resilient feature may be sufficient to hold the motor 100 in place.

Similarly, the cover 23 and the ribs 106 may be sized and arranged to remain generally rigid and without a resilient feature. The cover 23 may still apply a downward force on the motor 100, which may be held in place by the housing 22 that includes the resilient features 101 described above. The resilient features 101 in the housing 22 may provide the interference type fit and reaction forces on the motor 100 to hold the motor in place.

Illustratively, the housing 22 and cover 23 of the latch assembly 20 may be manufactured of a plastic material formed by a plastic injection molding process, by way of example and without limitation, but may also be formed from, or in combination with, for example, a metal material, a carbon fiber material, or other like materials.

A method 1000 for forming or manufacturing the latch assembly is also supported by the above description. The method 1000 may include providing 1002 the housing 22 having the motor seat 102, for instance by integrally forming the housing 22 and walls 104, and integrally forming the cover 23 and ribs 106. The integral forming may be performed by injection molding.

The method of assembly 1000 may include inserting 1004 the motor 100 into the motor seat 102 defined by the housing 22 and, in response thereto, deflecting a portion of the housing 22 or the walls 104. The method may include attaching 1006 the cover 23 to the housing and contacting and securing 1008 the motor with the ribs 106. In response to contacting the motor 100, the method may further include compressing 1010 the ribs 106 and deflecting the ribs 106, or deflecting the upper wall portion 107.

The housing 22 and cover 23 may be attached to one another to enclose at least a portion or the entirety of cavity 27 via a fastening mechanism. By way of example and without limitation, the housing 22 and cover 23 may be securely attached to one another via a plurality of threaded fasteners and/or coupled snap or hook members. It will be appreciated by those possessing ordinary skill in the art that any suitable fastening mechanism can be used, and that one or more of the aforementioned fastening mechanism can be used alone or in combination with one another.

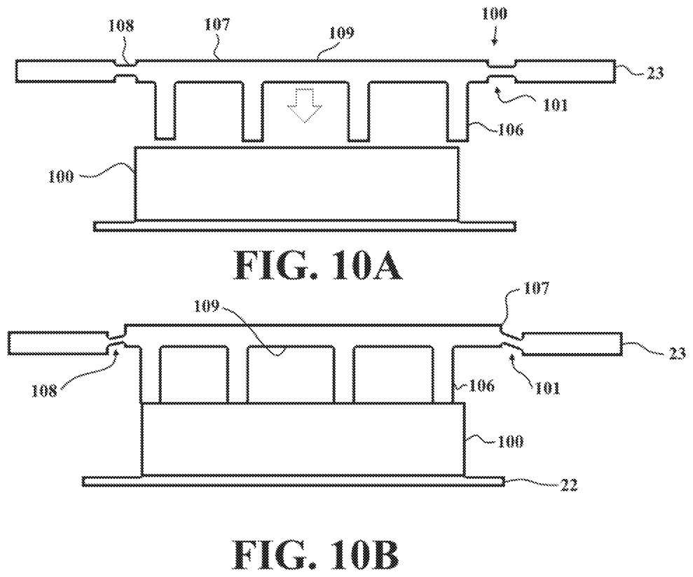

Now referring to FIGS. 12 and 13, there is shown an exemplary electrical latch assembly 20′, in accordance with an illustrative embodiment. In exemplary embodiment, electrical latch assembly 20′ operates for releasably latching a vehicle door 14 to a vehicle body 12 as generally shown in FIG. 1. Broadly, the electrical latch assembly 20′ includes a latch mechanism 22′ and an electrical portion 24′. The latch mechanism 22′ includes the mechanical components of the latch assembly for selectively opening and closing to release or engage a striker 28 on the vehicle body 12. The electrical portion 24′ has a fluid-tight electrical housing 26′ which contains the electrical components of the latch assembly to protect those components from fluid damage. This allows the entire electrical latch assembly 20′ to be positioned in areas of the vehicle door that may be exposed to water, grease or other fluids that could otherwise damage the electrical components that are protected by the fluid-tight electrical housing 26′ of the electrical portion 24′. The latch mechanism 22′ and the electrical housing 26′ are joined together with a plurality of fasteners 28′ or any suitable connection means. The electrical portion 24′ and the latch mechanism 22′ may be joined together and installed in the vehicle door as a single unit. This may allow for certain manufacturing advantages by simplifying the assembly of the vehicle door 12. The latch mechanism 22′ has a latch housing 60′ with an outer surface that presents a motor seat 62′. The electric motor 50′ is located within the motor seat 62′.

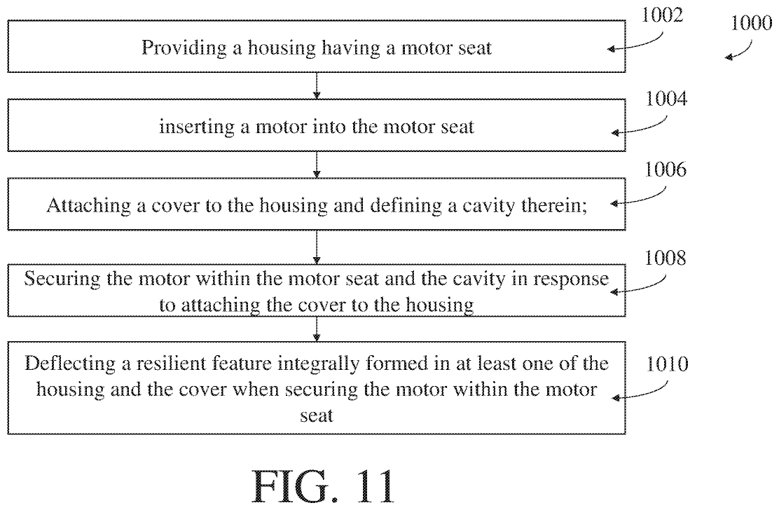

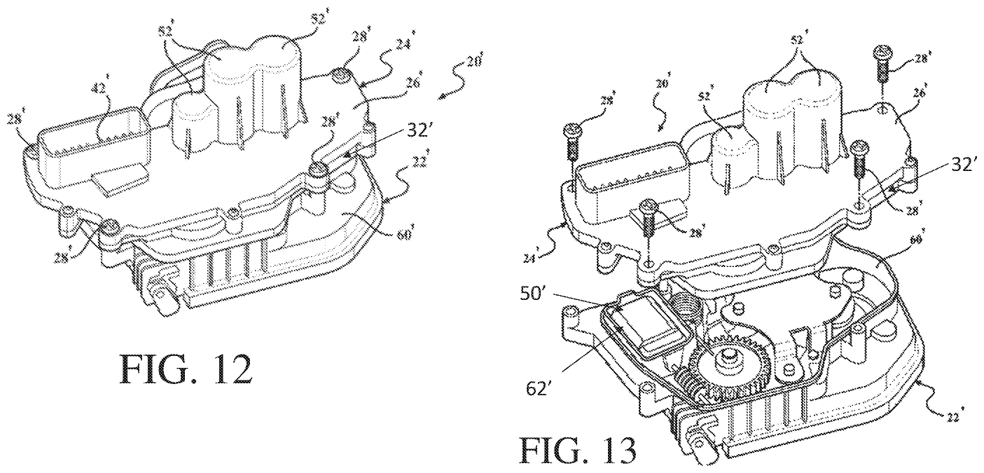

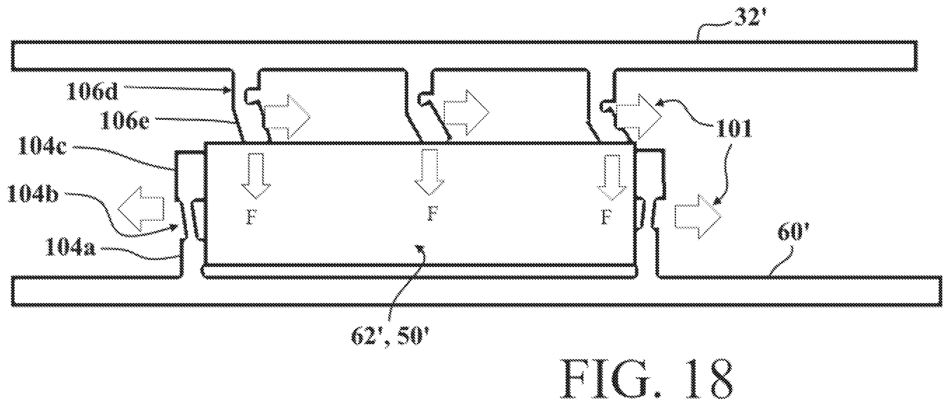

Now referring to FIGS. 14, and 15, the latch housing 60′ (e.g. housing 22) and the second cover piece 32′ (e.g. cover 23) are configured such that when they are joined together, the ribs 106 of the second cover piece 32′ are aligned with the motor seat 62′, and/or motor 50′ in the latch housing 60′. The resilient features 101 of the second cover piece 32′ (e.g. cover 23) are illustratively provided as ribs 106 and may be arranged to be flexible and to flex as shown in FIG. 18 in response to contacting the motor 100 when the cover 32′ is installed over the motor 100 that is placed within the motor seat 62′. The ribs 106 are shown in include neck portion 106d and a head portion 106e.

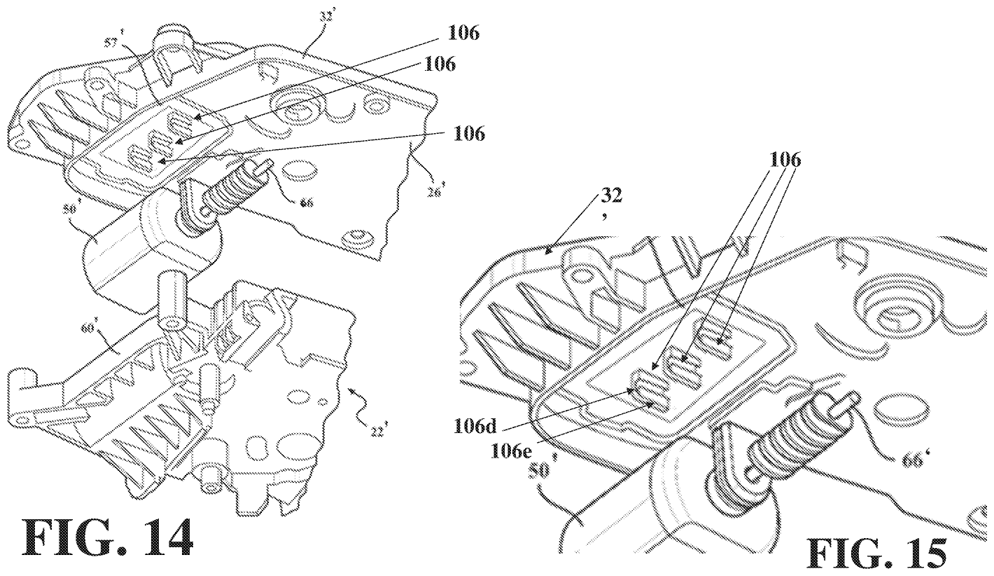

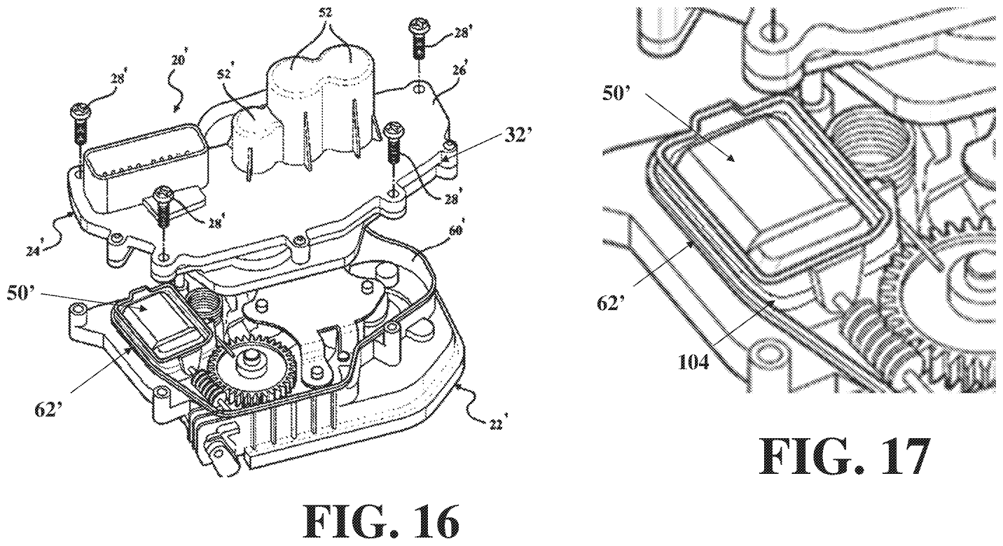

Referring to FIGS. 16-18, the resilient features 101 of the latch housing 60′ (e.g. housing 22) are shown to include walls 104, which may include a lower portion 104a having a first thickness, an upper portion 104b having a second thickness, which may be the same, smaller, or larger than the first thickness, and a middle portion 104c having a third thickness or reduced thickness, which is smaller than both the first and second thicknesses of the bottom portion 104a and upper portion 140b, respectively and which are configured to deflect as shown in FIG. 18, to provide the interference type fit for the motor 62′, and the force F applied by the resilient feature may be sufficient to hold the motor 62′ in place. It is recognized that various configurations of the resilient features 101 provide on both or one of the cover 32′ and the housing 60′ may be provided.

It will further be appreciated that the resilient features 101 described above with respect to the cover 23 and housing 22 may also be used for the cover 32′ and housing 60′, and vice-versa. Moreover, the various resilient features 101 described herein may be used in combination with each other.

While the teachings of the present disclosure are illustrated for seating a motor within a latch assembly to prevent vibrations between the motor and the housing of the latch assembly, the teachings may be applied for seating other type of components such as for example and without limitation a printed circuit board provided within the latch assembly or within a stand-alone latch control module, or other type of housing, an illustrative example being provided without limitation in U.S. Ser. No. 10/047,548 entitled “Latch assembly for latch operation of closure panels for vehicles”, the entire disclosure of which is incorporated herein by reference, or for seating a printed circuit board for a sensor module having a housing for containing a sensor printed circuit board such as for radar sensing, as illustrated in U.S. Ser. No. 10/443,292 entitled “Non-contact obstacle detection system for motor vehicles”, the entire disclosure of which is incorporated herein by reference.

While the above description constitutes a plurality of embodiments of the present invention, it will be appreciated that the present invention is subject to further modification and change without departing from the fair interpretation and intended meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch assembly for a vehicle closure panel, comprising:
a housing having an internal cavity configured for receipt of internal latch components;
a cover attached to said housing to enclose at least a portion of said internal cavity;
a motor disposed within the internal cavity of the housing and the cover;
a motor seat defined by the housing, wherein the motor is retained in the motor seat; and
a resilient feature defined by at least one of the housing and the cover, the resilient feature configured to deflect when the motor is retained in the motor seat and the cover is attached to the housing.

2. The latch assembly of claim 1, wherein the resilient feature comprises a reduced thickness portion of the housing or the cover, wherein the reduced thickness portion has a reduced thickness relative to an adjacent portion of the housing or the cover.

3. The latch assembly of claim 1, wherein the resilient feature is integrally formed and co-molded with the cover or housing.

4. The latch assembly of claim 1, wherein the resilient feature is disposed on both the housing and the cover.

5. The latch assembly of claim 1, wherein the resilient feature is disposed on the housing adjacent the motor seat.

6. The latch assembly of claim 5, wherein the motor seat includes a base and an upstanding wall portion, and the resilient feature is formed in the upstanding wall portion.

7. The latch assembly of claim 6, wherein the upstanding wall portion includes an upper portion, a lower portion, and a middle portion, and the resilient feature is defined by the middle portion, wherein the middle portion is thinner than the upper portion and the lower portion.

8. The latch assembly of claim 6, wherein the upstanding wall portion includes an upper portion and a lower portion, wherein the resilient feature is defined by the lower portion, wherein the lower portion is thinner than the upper portion, and the lower portion intersects the base.

9. The latch assembly of claim 6, wherein the resilient feature is defined by the base.

10. The latch assembly of claim 9, wherein the resilient feature is disposed adjacent an intersection of the upstanding wall portion and the base.

11. The latch assembly of claim 1, wherein the resilient feature is disposed on the cover above the motor.

12. The latch assembly of claim 11, wherein the resilient feature is disposed on a plurality of ribs that extend downward from an upper wall of the cover into the internal cavity, wherein the ribs contact the motor.

13. The latch assembly of claim 12, wherein the ribs include an upper portion and lower portion, wherein the upper portion is thinner than the lower portion, and the ribs are bent relative to a nominal position and compressed between the motor and the cover.

14. The latch assembly of claim 12, wherein the ribs include an upper portion, a lower portion, and a middle portion, wherein the middle portion is thinner than the upper portion and the lower portion, and the ribs are bent relative to a nominal position and compressed between the motor and the cover.

15. The latch assembly of claim 11, wherein the resilient feature is disposed on an upper wall of the cover, and a plurality of ribs extend from the upper wall into the cavity, and the resilient feature is disposed outwardly relative to the plurality of ribs.

16. A housing assembly, comprising:
a housing having an internal cavity configured for receipt of a component;
a cover attached to said housing to enclose at least a portion of said internal cavity;
a component disposed within the internal cavity of the housing and the cover;
a component seat defined by the housing, wherein the component is retained in the component seat; and
a resilient feature defined by at least one of the housing and the cover, the resilient feature configured to deflect when the component is retained in the motor seat and the cover is attached to the housing.

17. A method for assembling a latch assembly, the method comprising the steps of:
providing a housing having a motor seat;
inserting a motor into the motor seat;
attaching a cover to the housing and defining a cavity therein;
securing the motor within the motor seat and the cavity in response to attaching the cover to the housing; and
deflecting a resilient feature integrally formed in at least one of the housing and the cover when securing the motor within the motor seat.

18. The method of claim 17, wherein an upstanding wall integrally formed with the housing is deflected when the motor is secured, wherein the upstanding wall or a portion of a base of the motor seat has a reduced thickness portion relative to an adjacent portion.

19. The method of claim 17, wherein an upper wall portion of the cover is deflected when the motor is secured, and a plurality of ribs extend between the upper wall portion and contact the motor, and the upper wall portion includes a reduced thickness portion relative to an adjacent portion.

20. The method of claim 17, wherein a plurality of ribs integrally formed in the cover are deflected when the motor is secured, and the plurality of ribs include a reduced thickness portion relative to an adjacent portion.
